(19) United States
(12) Patent Application Publication
(10) Pub. No.: US 2023/0056459 A1
(43) Pub. Date: Feb. 23, 2023

(54) IMAGE PROCESSING DEVICE, METHOD OF GENERATING 3D MODEL, LEARNING METHOD, AND PROGRAM

(71) Applicant: SONY GROUP CORPORATION, Tokyo (JP)

(72) Inventor: Masato SHIMAKAWA, Saitama (JP)

(73) Assignee: SONY GROUP CORPORATION, Tokyo (JP)

(21) Appl. No.: 17/796,990

(22) PCT Filed: Feb. 8, 2021
(86) PCT No.: PCT/JP2021/004517

§ 371 Date: Aug. 2, 2022

(30) Foreign Application Priority Data
Feb. 28, 2020 (JP) 2020-033432

(51) Int. Cl. G06T 17/20; G06T 7/40; G06V 10/141; G06V 10/25; G06V 10/60

(52) U.S. Cl. CPC G06T 17/20; G06T 7/40; G06V 10/141; G06V 10/25; G06V 10/60

(57) ABSTRACT

An imaging unit (43) (first acquisition unit) of a video generation/display device (10a) (image processing device) acquires an image obtained by imaging, at each time, a subject (18) (object) in a situation in which the state of an illumination device (11) changes at each time. An illumination control information input unit (41) (second acquisition unit) acquires the state of the illumination device (11) at each time when the imaging unit (43) captures an image. Then, a foreground clipping processing unit (44a) (clipping unit) clips the subject (18) from the image captured by the imaging unit (43) based on the state of the illumination device (11) at each time acquired by the illumination control information input unit (41). A modeling processing unit (46) (model generation unit) generates a 3D model (18M) of the subject (18) clipped by the foreground clipping processing unit (44a).

### FIELD

The present disclosure relates to an image processing device, a method of generating a 3D model, a learning method, and a program, and more particularly, to an image processing device, a method of generating a 3D model, a learning method, and a program capable of generating a high-quality 3D model and a volumetric video even when the state of illumination changes at each time.

### BACKGROUND

There has been conventionally proposed methods of generating a 3D object in viewing space by using information obtained by sensing real 3D space, for example, a multi-viewpoint video obtained by imaging a subject from different viewpoints and generating a video (volumetric video) in which the object appears as if existing in the viewing space (e.g., Patent Literature 1).

### CITATION LIST

### Patent Literature

Patent Literature 1: WO 2017/082076 A

### SUMMARY

### Technical Problem

In Patent Literature 1, however, a subject is clipped in a stable illumination environment such as a dedicated studio. Patent Literature 1 does not mention clipping of a subject in an environment such as a live venue where an illumination environment changes from moment to moment.

Change in an illumination environment makes it difficult to perform processing of clipping a region to be modeled (foreground clipping processing) with high accuracy. Furthermore, since the state of illumination is reflected in the texture generated from the image obtained by imaging a subject, the subject is observed in a color different from the original color of the subject. Therefore, there is a problem of difficulty in canceling the influence of illumination.

The present disclosure proposes an image processing device, a method of generating a 3D model, a learning method, and a program capable of generating a high-quality 3D model and a volumetric video even when the state of illumination changes at each time.

### Solution to Problem

To solve the problems described above, an image processing device according to an embodiment of the present disclosure includes: a first acquisition unit that acquires an image obtained by imaging, at each time, an object in a situation in which a state of illumination changes at each time; a second acquisition unit that acquires the state of illumination at each time; a clipping unit that clips a region of the object from the image based on the state of illumination at each time acquired by the second acquisition unit; and a model generation unit that generates a 3D model of the object clipped by the clipping unit.

Moreover, an image processing device according to an embodiment of the present disclosure includes: an acquisition unit that acquires a 3D model generated by clipping an object from an image obtained by imaging, at each time, the object in a situation in which a state of illumination changes at each time based on the state of illumination which changes at each time; and a rendering unit that performs rendering of the 3D model acquired by the acquisition unit.

### BRIEF DESCRIPTION OF DRAWINGS

FIG. 1 outlines a flow in which a server device generates a 3D model of a subject.

FIG. 2 illustrates the contents of data necessary for expressing the 3D model.

FIG. 3 is a block diagram illustrating one example of the device configuration of a video generation/display device of a first embodiment.

FIG. 4 is a hardware block diagram illustrating one example of the hardware configuration of a server device of the first embodiment.

FIG. 5 is a hardware block diagram illustrating one example of the hardware configuration of a mobile terminal of the first embodiment.

FIG. 6 is a functional block diagram illustrating one example of the functional configuration of the video generation/display device of the first embodiment.

FIG. 7 illustrates one example of a data format of input/output data according to the video generation/display device of the first embodiment.

FIG. 8 illustrates processing of an illumination information processing unit simulating an illuminated background image.

FIG. 9 illustrates a method of texture correction processing.

FIG. 10 illustrates one example of a video displayed by the video generation/display device of the first embodiment.

FIG. 11 is a flowchart illustrating one example of the flow of illumination information processing in the first embodiment.

FIG. 12 is a flowchart illustrating one example of the flow of foreground clipping processing in the first embodiment.

FIG. 13 is a flowchart illustrating one example of the flow of texture correction processing in the first embodiment.

FIG. 14 is a functional block diagram illustrating one example of the functional configuration of a video generation/display device of a second embodiment.

FIG. 15 outlines foreground clipping processing using deep learning.

FIG. 16 outlines texture correction processing using deep learning.

FIG. 17 is a flowchart illustrating one example of the flow of foreground clipping processing in the second embodiment.

FIG. 18 is a flowchart illustrating one example of the flow of texture correction processing in the second embodiment.

FIG. 19 is a flowchart illustrating one example of a procedure of generating learning data.

### DESCRIPTION OF EMBODIMENTS

Embodiments of the present disclosure will be described in detail below with reference to the drawings. Note that, in each of the following embodiments, the same reference signs are attached to the same parts to omit duplicate description.

Furthermore, the present disclosure will be described in accordance with the following item order.

1. First Embodiment

1-1. Description of Assumption —Generation of 3D Model

1-2. Description of Assumption —Data Structure of 3D Model

1-3. Schematic Configuration of Video Generation/Display Device

1-4. Hardware Configuration of Server Device

1-5. Hardware Configuration of Mobile Terminal

1-6. Functional Configuration of Video Generation/Display Device

1-7. Method of Simulating Illuminated Background Image

1-8. Foreground Clipping Processing

1-9. Texture Correction Processing

1-10. Flow of Illumination Information Processing Performed by Video Generation/Display Device of First Embodiment

1-11. Flow of Foreground Clipping Processing Performed by Video Generation/Display Device of First Embodiment

1-12. Flow of Texture Correction Processing Performed by Video Generation/Display Device of First Embodiment

1-13. Effects of First Embodiment

2. Second Embodiment

2-1. Functional Configuration of Video Generation/Display Device of Second Embodiment

2-2. Foreground Clipping Processing

2-3. Texture Correction Processing

2-4. Flow of Processing Performed by Video Generation/Display Device of Second Embodiment

2-5. Variation of Second Embodiment

2-6. Effects of Second Embodiment

### 1. First Embodiment

[1-1. Description of Assumption —Generation of 3D Model]

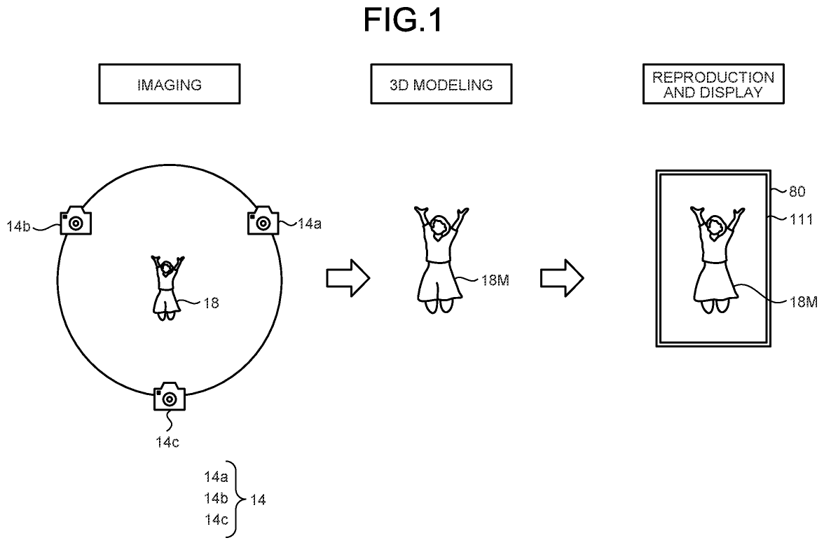

FIG. 1 outlines a flow in which a server device generates a 3D model of a subject.

As illustrated in FIG. 1, a 3D model 18M of a subject 18 is obtained by performing processing of imaging the subject 18 with a plurality of cameras 14 (14a, 14b, and 14c) and generating the 3D model 18M, which has 3D information on the subject 18, by 3D modeling.

Specifically, as illustrated in FIG. 1, the plurality of cameras 14 is arranged outside the subject 18 so as to surround the subject 18 in the real world and face the subject 18. FIG. 1 illustrates an example of three cameras 14a, 14b, and 14c arranged around the subject 18. Note that, in FIG. 1, the subject 18 is a person. Furthermore, the number of cameras 14 is not limited to three, and a larger number of cameras may be provided.

The 3D modeling is performed by using a plurality of viewpoint images volumetrically captured in synchronization by the three cameras 14a, 14b, and 14c from different viewpoints. The 3D model 18M of the subject 18 is generated in units of video frames of the three cameras 14a, 14b, and 14c.

The 3D model 18M has the 3D information on the subject 18. The 3D model 18M has shape information representing the surface shape of the subject 18 in a format of, for example, mesh data called a polygon mesh. In the mesh data, information is expressed by connections of a vertex and a vertex. Furthermore, the 3D model 18M has texture information representing the surface state of the subject 18 corresponding to each polygon mesh. Note that the format of information of the 3D model 18M is not limited thereto. Other format of information may be used.

When the 3D model 18M is reconstructed, so-called texture mapping is performed. In the texture mapping, a texture representing the color, pattern, and feel of a mesh is attached in accordance with the mesh position. In the texture mapping, a view dependent (hereinafter, referred to as VD) texture is desirably attached to improve the reality of the 3D model 18M. This changes the texture in accordance with a viewpoint position when the 3D model 18M is captured from any virtual viewpoint, so that a virtual image with higher quality can be obtained. This, however, increases a calculation amount, so that a view independent (hereinafter, referred to as VI) texture may be attached to the 3D model 18M.

Content data including the read 3D model 18M is transmitted to a mobile terminal 80 serving as a reproduction device and reproduced. A video including a 3D shape is displayed on a viewing device of a user (viewer) by rendering the 3D model 18M and reproducing the content data including the 3D model 18M.

In the example of FIG. 1, the mobile terminal 80 such as a smartphone and a tablet terminal is used as the viewing device. That is, an image including the 3D model 18M is displayed on a display 111 of the mobile terminal 80.

[1-2. Description of Assumption —Data Structure of 3D Model]

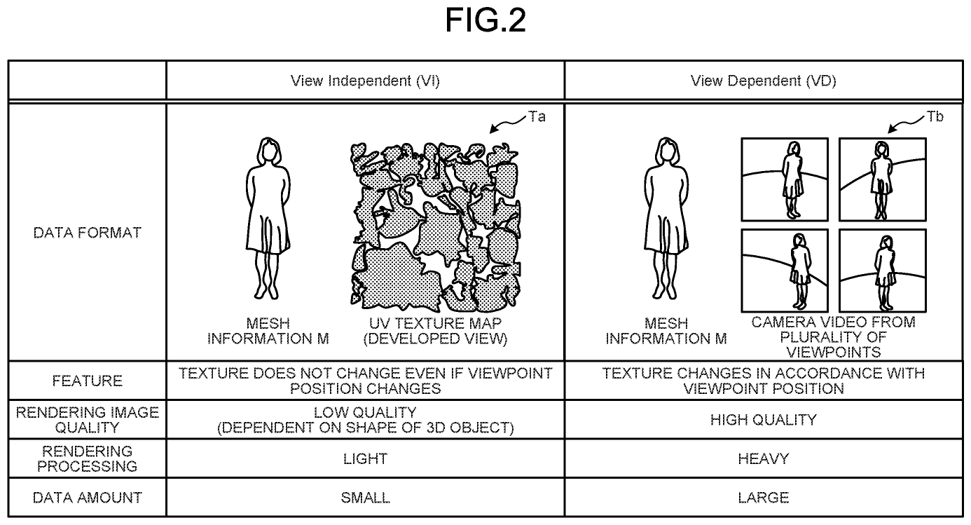

Next, the contents of data necessary for expressing the 3D model 18M will be described with reference to FIG. 2. FIG. 2 illustrates the contents of data necessary for expressing the 3D model.

The 3D model 18M of the subject 18 is expressed by mesh information M and texture information T. The mesh information M indicates the shape of the subject 18. The texture information T indicates the feel (e.g., color shade and pattern) of the surface of the subject 18.

The mesh information M represents the shape of the 3D model 18M by defining some parts on the surface of the 3D model 18M as vertices and connecting the vertices (polygon mesh). Furthermore, depth information Dp (not illustrated) may be used instead of the mesh information M. The depth information Dp represents the distance from a viewpoint position for observing the subject 18 to the surface of the subject 18. The depth information Dp of the subject 18 is calculated based on a parallax of the subject 18 in the same region. The parallax is detected from images captured by, for example, adjacent imaging devices. Note that the distance to the subject 18 may be obtained by installing a sensor (e.g., time of flight (TOF) camera) and an infrared (IR) camera including a ranging mechanism instead of the imaging device.

In the present embodiment, two types of data are used as the texture information T. One is texture information Ta that does not depend on a viewpoint position (VI) for observing the 3D model 18M. The texture information Ta is data obtained by storing a texture of the surface of the 3D model 18M in a format of a developed view such as a UV texture map in FIG. 2. That is, the texture information Ta is view independent data. For example, when the 3D model 18M is a person wearing clothes, a UV texture map including the pattern of the clothes and the skin and hair of the person is prepared as the texture information Ta. Then, the 3D model 18M can be drawn by attaching the texture information Ta corresponding to the mesh information M on the surface of the mesh information M representing the 3D model 18M (VI rendering). Then, at this time, even when an observation position of the 3D model 18M changes, the same texture information Ta is attached to meshes representing the same region. As described above, the VI rendering using the texture information Ta is executed by attaching the texture information Ta of the clothes worn by the 3D model 18M to all the meshes representing the parts of the clothes. Therefore, in general, the VI rendering using the texture information Ta has a small data size and a light calculation load of rendering processing. Note, however, that the attached texture information Ta is uniform, and the texture does not change even when the observation position is changed. Therefore, the quality of the texture is generally low.

The other texture information T is texture information Tb that depends on a viewpoint position (VD) for observing the 3D model 18M. The texture information Tb is expressed by a set of images obtained by observing the subject 18 from multiple viewpoints. That is, the texture information Ta is view dependent data. Specifically, when the subject 18 is observed by N cameras, the texture information Tb is expressed by N images simultaneously captured by the respective cameras. Then, when the texture information Tb is rendered in any mesh of the 3D model 90 M, all the regions corresponding to the corresponding mesh are detected from the N images. Then, each texture appearing in the plurality of detected regions is weighted and attached to the corresponding mesh. As described above, the VD rendering using the texture information Tb generally has a large data size and a heavy calculation load of rendering processing. The attached texture information Tb, however, changes in accordance with an observation position, so that the quality of a texture is generally high.

[1-3. Schematic Configuration of Video Generation/Display Device]

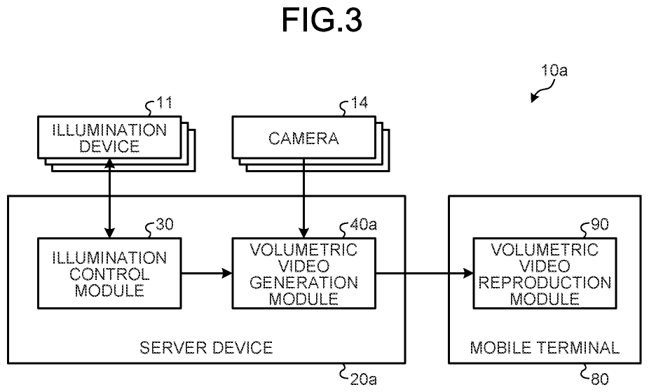

Next, the schematic configuration of a video generation/display device of a first embodiment will be described with reference to FIG. 3. FIG. 3 is a block diagram illustrating one example of the device configuration of the video generation/display device of the first embodiment.

A video generation/display device 10a generates the 3D model 18M of the subject 18. Furthermore, the video generation/display device 10a reproduces a volumetric video obtained by viewing the generated 3D model 18M of the subject 18 from a free viewpoint. The video generation/display device 10a includes a server device 20a and the mobile terminal 80. Note that the video generation/display device 10a is one example of an image processing device in the present disclosure. Furthermore, the subject 18 is one example of an object in the present disclosure.

The server device 20a generates the 3D model 18M of the subject 18. The server device 20a further includes an illumination control module 30 and a volumetric video generation module 40a.

The illumination control module 30 sets illumination control information 17 at each time to an illumination device 11. The illumination control information 17 includes, for example, the position, orientation, color, luminance, and the like of illumination. Note that a plurality of illumination devices 11 is connected to illuminate the subject 18 from different directions. A detailed functional configuration of the illumination control module 30 will be described later.

The volumetric video generation module 40a generates the 3D model 18M of the subject 18 based on camera images captured by a plurality of cameras 14 installed so as to image the subject 18 from different positions. A detailed functional configuration of the volumetric video generation module 40a will be described later.

The mobile terminal 80 receives the 3D model 18M of the subject 18 transmitted from the server device 20a. Then, the mobile terminal 80 reproduces the volumetric video obtained by viewing the 3D model 18M of the subject 18 from a free viewpoint. The mobile terminal 80 includes a volumetric video reproduction module 90. Note that the mobile terminal 80 may be of any type as long as the mobile terminal 80 has a video reproduction function, such as a smartphone, a television monitor, and a head mount display (HMD), specifically.

The volumetric video reproduction module 90 generates a volumetric video by rendering images at each time when the 3D model 18M of the subject 18 generated by the volumetric video generation module 40a is viewed from a free viewpoint. Then, the volumetric video reproduction module 90 reproduces the generated volumetric video. A detailed functional configuration of the volumetric video reproduction module 90 will be described later.

[1-4. Hardware Configuration of Server Device]

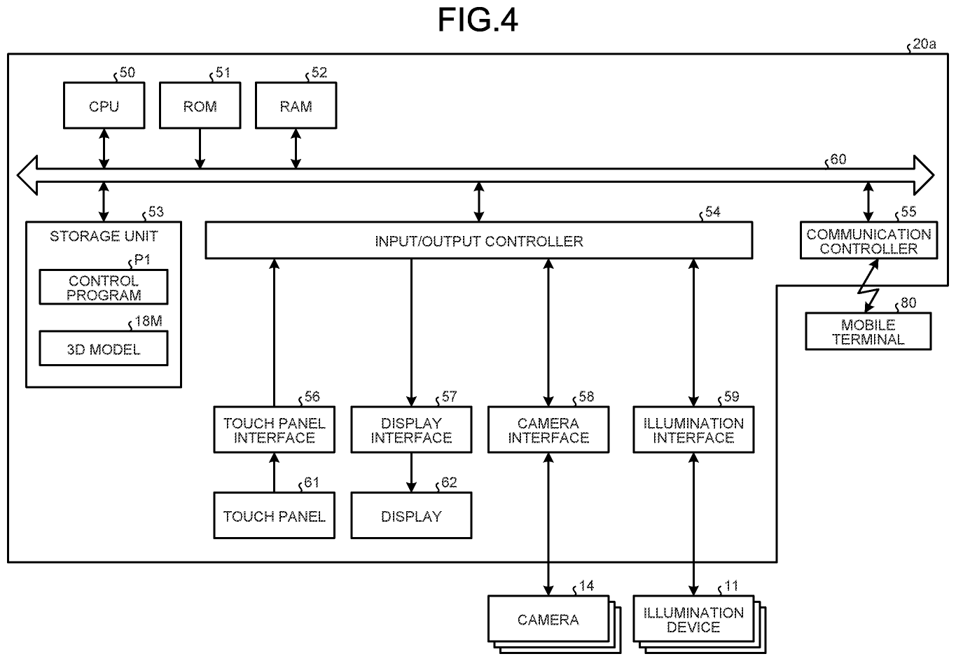

Next, the hardware configuration of the server device 20a will be described with reference to FIG. 4. FIG. 4 is a hardware block diagram illustrating one example of the hardware configuration of the server device of the first embodiment.

The server device 20a has a configuration in which a central processing unit (CPU) 50, a read only memory (ROM) 51, a random access memory (RAM) 52, a storage unit 53, an input/output controller 54, and a communication controller 55 are connected by an internal bus 60.

The CPU 50 controls the entire operation of the server device 20a by developing and executing a control program P1 stored in the storage unit 53 and various data files stored in the ROM 51 on the RAM 52. That is, the server device 20a has a configuration of a common computer operated by the control program P1. Note that the control program P1 may be provided via a wired or wireless transmission medium such as a local area network, the Internet, and digital satellite broadcasting. Furthermore, the server device 20a may execute a series of pieces of processing with hardware. Note that processing of the control program P1 executed by the CPU 50 may be performed in chronological order along the order described in the present disclosure, or may be performed in parallel or at necessary timing such as timing when a call is made.

The storage unit 53 includes, for example, a flash memory, and stores the control program P1 executed by the CPU 50 and the 3D model 18M of the subject 18. Furthermore, the 3D model 18M may be generated by the server device 20a itself, or may be acquired from another external device.

The input/output controller 54 acquires operation information of a touch panel 61 via a touch panel interface 56. The touch panel 61 is stacked on a display 62 that displays information related to the illumination device 11, the cameras 14, and the like. Furthermore, the input/output controller 54 displays image information, information related to the illumination device 11, and the like on the display 62 via a display interface 57.

Furthermore, the input/output controller 54 is connected to the camera 14 via a camera interface 58. The input/output controller 54 performs imaging control of the camera 14 to simultaneously image the subject 18 with the plurality of cameras 14 arranged so as to surround the subject 18. Furthermore, the input/output controller 54 inputs a plurality of captured images to the server device 20a.

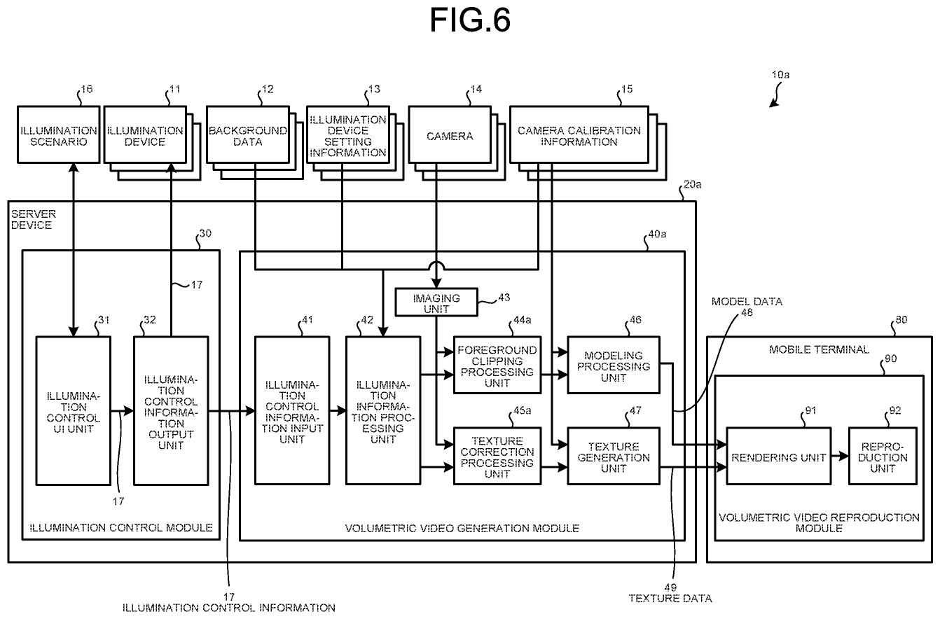

Furthermore, the input/output controller 54 is connected to the illumination device 11 via an illumination interface 59. The input/output controller 54 outputs the illumination control information 17 (see FIG. 6) for controlling an illumination state to the illumination device 11.

Moreover, the server device 20a communicates with the mobile terminal 80 via the communication controller 55. This causes the server device 20a to transmit a volumetric video of the subject 18 to the mobile terminal 80.

[1-5. Hardware Configuration of Mobile Terminal]

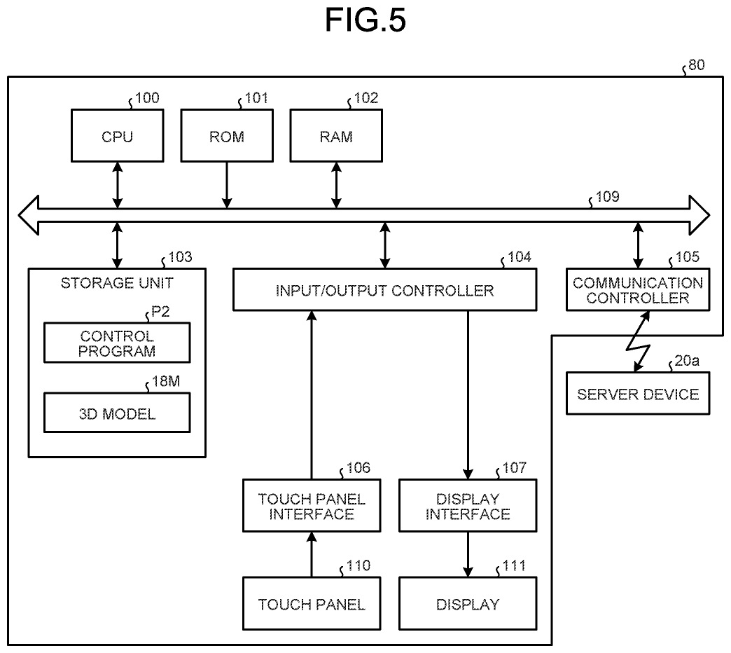

Next, the hardware configuration of the mobile terminal 80 will be described with reference to FIG. 5. FIG. 5 is a hardware block diagram illustrating one example of the hardware configuration of the mobile terminal of the first embodiment.

The mobile terminal 80 has a configuration in which a CPU 100, a ROM 101, a RAM 102, a storage unit 103, an input/output controller 104, and a communication controller 105 are connected by an internal bus 109.

The CPU 100 controls the entire operation of the mobile terminal 80 by developing and executing a control program P2 stored in the storage unit 103 and various data files stored in the ROM 101 on the RAM 102. That is, the mobile terminal 80 has a configuration of a common computer that is operated by the control program P2. Note that the control program P2 may be provided via a wired or wireless transmission medium such as a local area network, the Internet, and digital satellite broadcasting. Furthermore, the mobile terminal 80 may execute a series of pieces of processing with hardware. Note that processing of the control program P2 executed by the CPU 100 may be performed in chronological order along the order described in the present disclosure, or may be performed in parallel or at necessary timing such as timing when a call is made.

The storage unit 103 includes, for example, a flash memory, and stores the control program P2 executed by the CPU 100 and the 3D model 18M acquired from the server device 20a. Note that the 3D model 18M is a 3D model of the specific subject 18 indicated by the mobile terminal 80 to the server device 20a, that is, the subject 18 to be drawn. Then, the 3D model 18M includes the mesh information M, the texture information Ta, and the texture information Tb as described above.

The input/output controller 104 acquires operation information of a touch panel 110 via a touch panel interface 106. The touch panel 110 is stacked on the display 111 that displays information related to the mobile terminal 80. Furthermore, the input/output controller 104 displays a volumetric video and the like including the subject 18 on the display 111 via a display interface 107.

Furthermore, the mobile terminal 80 communicates with the server device 20a via the communication controller 105. This causes the mobile terminal 80 to acquire information related to the 3D model 18M and the like from the server device 20a.

[1-6. Functional Configuration of Video Generation/Display Device]

Next, the functional configuration of the video generation/display device 10a of the first embodiment will be described with reference to FIG. 6. FIG. 6 is a functional block diagram illustrating one example of the functional configuration of the video generation/display device of the first embodiment.

The CPU 50 of the server device 20a develops and operates the control program P1 on the RAM 52 to implement, as functional units, an illumination control UI unit 31, an illumination control information output unit 32, an illumination control information input unit 41, an illumination information processing unit 42, an imaging unit 43, a foreground clipping processing unit 44a, a texture correction processing unit 45a, a modeling processing unit 46, and a texture generation unit 47 in FIG. 6.

The illumination control UI unit 31 gives the illumination control information 17 such as luminance, color, and an illumination direction to the illumination device 11 via the illumination control information output unit 32. Specifically, the illumination control UI unit 31 transmits the illumination control information 17 corresponding to the operation contents set by an operator operating the touch panel 61 on a dedicated UI screen to the illumination control information output unit 32. Note that an illumination scenario 16 may be preliminarily generated and stored in the illumination control UI unit 31. The illumination scenario 16 indicates how to set the illumination device 11 over time.

The illumination control information output unit 32 receives the illumination control information 17 transmitted from the illumination control UI unit 31. Furthermore, the illumination control information output unit 32 transmits the received illumination control information 17 to the illumination device 11, the illumination control information input unit 41, and an illumination simulation control unit 73 to be described later.

The illumination control information input unit 41 receives the illumination control information 17 from the illumination control information output unit 32. Furthermore, the illumination control information input unit 41 transmits the illumination control information 17 to the illumination information processing unit 42. Note that the illumination control information input unit 41 is one example of a second acquisition unit in the present disclosure.

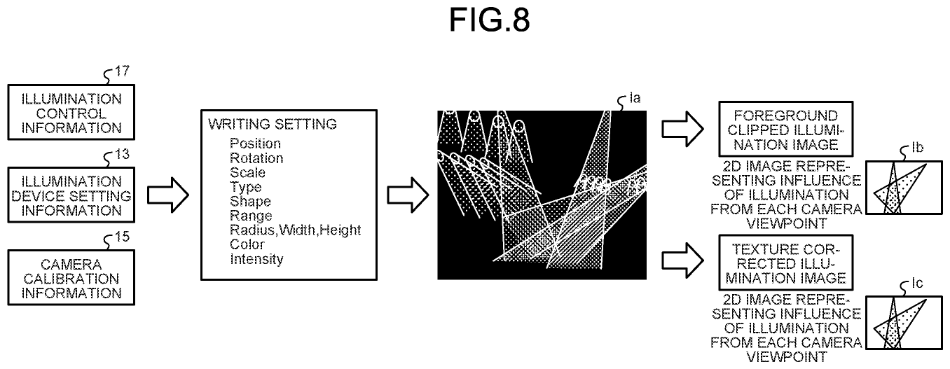

The illumination information processing unit 42 simulates an illuminated background image based on the state of illumination at that time, that is, an image in which illumination is emitted without the subject 18 by using the illumination control information 17, background data 12, illumination device setting information 13, and camera calibration information 15. Details will be described later (see FIG. 8).

The imaging unit 43 acquires an image obtained by the camera 14 imaging, at each time, the subject 18 (object) in a situation in which the state of illumination changes at each time. Note that the imaging unit 43 is one example of a first acquisition unit in the present disclosure.

The foreground clipping processing unit 44a clips the region of the subject 18 (object) from the image captured by the camera 14 based on the state of the illumination device 11 at each time acquired by the illumination control information input unit 41. Note that the foreground clipping processing unit 44a is one example of a clipping unit in the present disclosure. Note that the contents of specific processing performed by the foreground clipping processing unit 44a will be described later.

The texture correction processing unit 45a corrects the texture of the subject 18 appearing in the image captured by the camera 14 in accordance with the state of the illumination device 11 at each time based on the state of the illumination device 11 at each time acquired by the illumination control information input unit 41. Note that the texture correction processing unit 45a is one example of a correction unit in the present disclosure. The contents of specific processing performed by the texture correction processing unit 45a will be described later.

The modeling processing unit 46 generates a 3D model of the subject 18 (object) clipped by the foreground clipping processing unit 44a. Note that the modeling processing unit 46 is one example of a model generation unit in the present disclosure.

The texture generation unit 47 collects pieces of texture information from the cameras 14, performs compression and encoding processing, and transmits the texture information to the volumetric video reproduction module 90.

Furthermore, the CPU 100 of the mobile terminal 80 develops and operates the control program P2 on the RAM 102 to implement a rendering unit 91 and a reproduction unit 92 in FIG. 6 as functional units.

The rendering unit 91 draws (renders) the 3D model and the texture of the subject 18 (object) acquired from the volumetric video generation module 40a. Note that the rendering unit 91 is one example of a drawing unit in the present disclosure.

The reproduction unit 92 reproduces the volumetric video drawn by the rendering unit 91 on the display 111.

Note that, although not illustrated in FIG. 6, the volumetric video reproduction module 90 may be configured to acquire model data 48 and texture data 49 from a plurality of volumetric video generation modules 40a located at distant places. Then, the volumetric video reproduction module 90 may be used for combining a plurality of objects imaged at the distant places into one volumetric video and reproducing the volumetric video. In the case, although illumination environments at distant places are ordinarily different, the 3D model 18M of the subject 18 generated by the volumetric video generation module 40a is not influenced by illumination at the time of model generation as described later. The volumetric video reproduction module 90 thus can combine a plurality of 3D models 18M generated in the different illumination environments and reproduce the plurality of 3D models 18M in any illumination environment.

[1-7. Method of Simulating Illuminated Background Image]

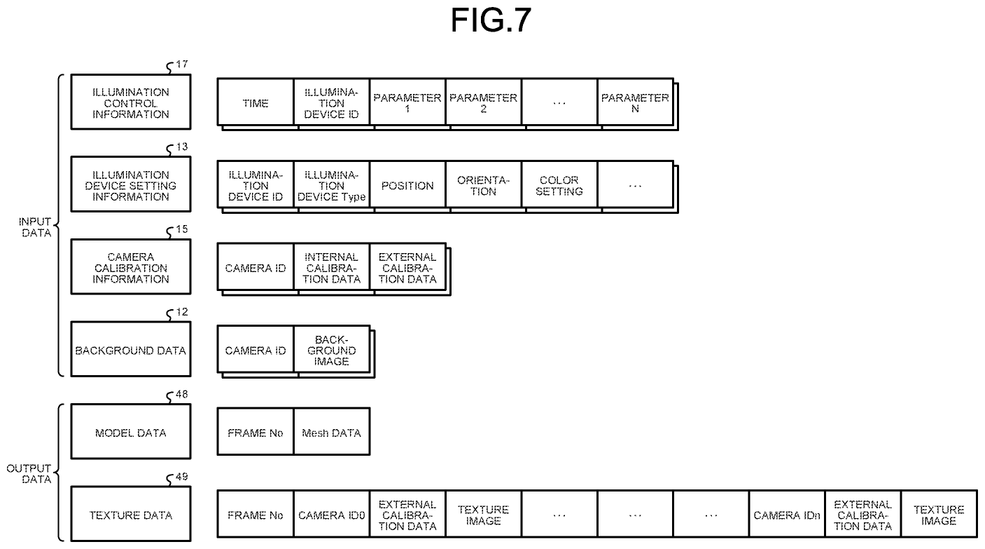

Next, the contents of processing of the illumination information processing unit simulating an illuminated background image will be described with reference to FIGS. 7 and 8. FIG. 7 illustrates one example of a data format of input/output data according to the video generation/display device of the first embodiment. FIG. 8 illustrates the processing of the illumination information processing unit simulating an illuminated background image.

The Illumination control information 17 is input from the illumination control information output unit 32 to the illumination information processing unit 42. Furthermore, the illumination device setting information 13, the camera calibration information 15, and the background data 12 are input to the illumination information processing unit 42.

These pieces of input information have the data format in FIG. 7. The illumination control information 17 is obtained by writing various parameter values given to the illumination device 11 at each time and for each illumination device 11.

The illumination device setting information 13 is obtained by writing various parameter values indicating the initial state of the illumination device 11 for each illumination device 11. Note that the written parameters are, for example, the type, installation position, installation direction, color setting, luminance setting, and the like of the illumination device 11.

The camera calibration information 15 is obtained by writing internal calibration data and external calibration data of the cameras 14 for each camera 14. The internal calibration data relates to internal parameters (parameter for performing image distortion correction finally obtained by lens or focus setting) unique to the camera 14. The external calibration data relates to the position and orientation of the camera 14.

The background data 12 is obtained by storing a background image preliminarily captured by each camera 14 in a predetermined illumination state.

Then, the foreground clipping processing unit 44a of the volumetric video generation module 40a outputs the model data 48 obtained by clipping the region of the subject 18 from the image captured by the camera 14 in consideration of the time variation of the illumination device 11. Furthermore, the texture correction processing unit 45a of the volumetric video generation module 40a outputs the texture data 49 from which the influence of the illumination device 11 is removed.

The model data 48 is obtained by storing, for each frame, mesh data of the subject 18 in the frame.

The texture data 49 is obtained by storing the external calibration data and a texture image of each camera 14 for each frame. Note that, when the positional relation between the cameras 14 is fixed, the external calibration data is required to be stored only in a first frame. In contrast, when the positional relation between the cameras 14 changes, the external calibration data is stored in each frame in which the positional relation between the cameras 14 has changed.

The illumination information processing unit 42 generates an illuminated background image Ia in FIG. 8 in order for the foreground clipping processing unit 44a to clip the subject 18 in consideration of the time variation of the illumination device 11. The illuminated background image Ia is generated at each time and for each camera 14.

More specifically, the illumination information processing unit 42 calculates the setting state of the illumination device 11 at each time based on the illumination control information 17 and the illumination device setting information 13 at the same time.

The illumination information processing unit 42 performs distortion correction on the background data 12 obtained by each camera 14 by using the camera calibration information 15 of each camera 14. Then, the illumination information processing unit 42 generates the illuminated background image Ia by simulating an illumination pattern based on the setting state of the illumination device 11 at each time for the distortion-corrected background data 12.

The illuminated background image Ia generated in this way is used as a foreground clipped illumination image Ib and a texture corrected illumination image Ic. The foreground clipped illumination image Ib and the texture corrected illumination image Ic are substantially the same image information, but will be separately described for convenience in the following description.

The foreground clipped illumination image Ib and the texture corrected illumination image Ic are 2D image information indicating in what state illumination is observed at each time by each camera 14. Note that the format of information is not limited to image information as long as the information indicates in what sate the illumination is observed.

[1-8. Foreground Clipping Processing]

The above-described foreground clipped illumination image Ib represents an illumination state predicted to be captured by the corresponding camera 14 at the corresponding time. The foreground clipping processing unit 44a (see FIG. 6) clips a foreground, that is, the region of the subject 18 by using a foreground/background difference determined by subtracting the foreground clipped illumination image Ib from an image actually captured by the camera 14 at the same time.

Note that the foreground clipping processing unit 44a may perform chroma key processing at the time. Note, however, that the background color differs for each region due to the influence of illumination in the present embodiment. Therefore, the foreground clipping processing unit 44a sets a threshold of a color to be determined to be a background for each region of the foreground clipped illumination image Ib without performing the chroma key processing based on a usually used single background color. Then, the foreground clipping processing unit 44a discriminates whether the color is the background and clips the foreground by comparing the luminance of the image actually captured by the camera 14 with the set threshold.

Furthermore, the foreground clipping processing unit 44a may clip the region of the subject 18 by using both the foreground/background difference and the chroma key processing.

[1-9. Texture Correction Processing]

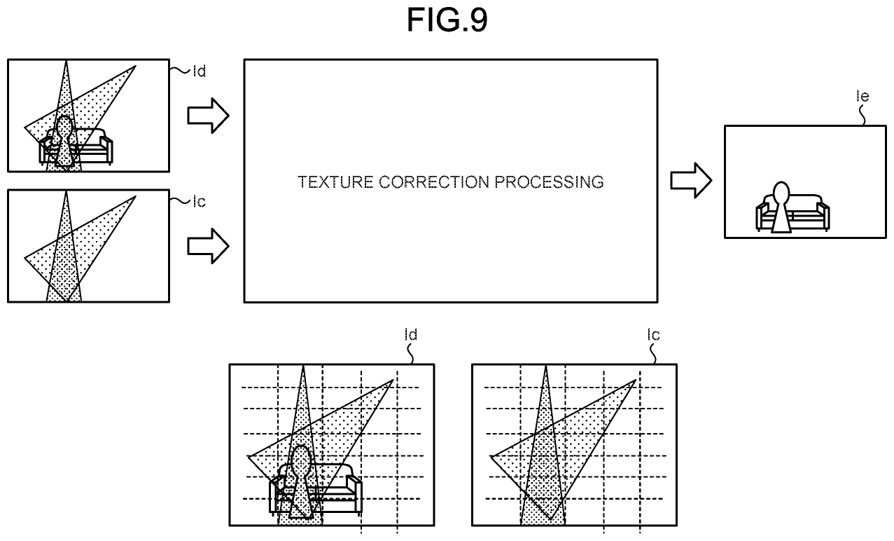

Next, texture correction processing performed by the video generation/display device 10a will be described with reference to FIG. 9. FIG. 9 illustrates a method of the texture correction processing.

The texture correction processing unit 45a (see FIG. 6) performs color correction on the texture of the subject 18 appearing in the image captured by the camera 14 in accordance with the state of the illumination device 11 at each time.

The texture correction processing unit 45a performs similar color correction on the above-described texture corrected illumination image Ic and a camera image Id actually captured by the camera 14. Note, however, that, in the present embodiment, the texture of the subject 18 differs for each region due to the influence of illumination, so that, as illustrated in FIG. 9, each of the texture corrected illumination image Ic and the camera image Id is divided into a plurality of small regions of the same size, and color correction is executed for each small region. Note that the color correction is widely performed in digital image processing, and is only required to be performed in accordance with a known method.

The texture correction processing unit 45a generates and outputs a texture corrected image Ie as a result of performing the texture correction processing. That is, the texture corrected image Ie indicates a texture estimated to be observed under standard illumination.

Note that the texture correction processing needs to be applied only to the region of the subject 18, so that the texture correction processing may be performed only on the region of the subject 18 clipped by the above-described foreground clipping processing in the camera image Id.

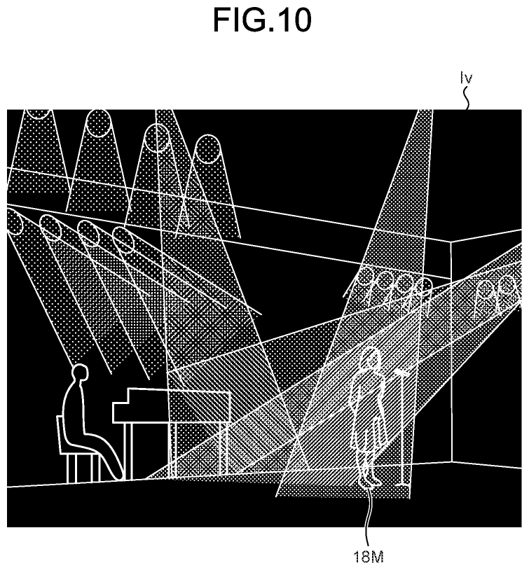

The 3D model 18M of the subject 18 independent of the illumination state can be obtained by the foreground clipping processing and the texture correction processing as described above. Then, the volumetric video reproduction module 90 generates and displays a volumetric video Iv in FIG. 10. In the volumetric video Iv, illumination information at the same time when the camera 14 has captured the camera image Id is reproduced, and the 3D model 18M of the subject 18 is drawn.

Furthermore, when a plurality of objects generated in different illumination states is combined into one volumetric video, the influence of illumination at the time of imaging can be removed.

[1-10. Flow of Illumination Information Processing Performed by Video Generation/Display Device of First Embodiment]

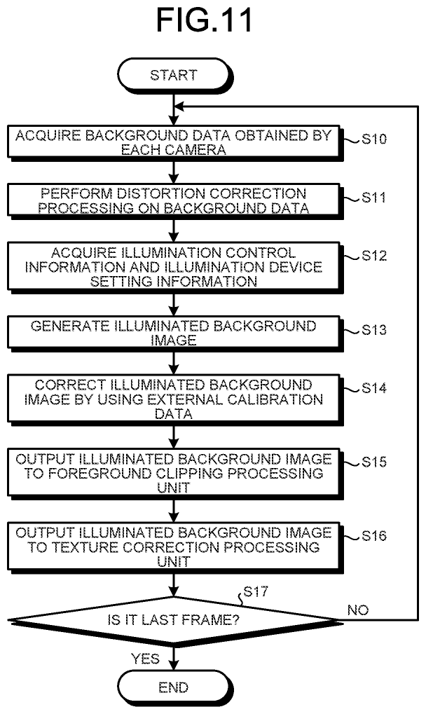

Next, the flow of illumination information processing performed by the video generation/display device 10a will be described with reference to FIG. 11. FIG. 11 is a flowchart illustrating one example of the flow of the illumination information processing in the first embodiment.

The illumination information processing unit 42 acquires the background data 12 preliminarily obtained by each camera 14 (Step S10).

The illumination information processing unit 42 performs distortion correction on the background data 12 acquired in Step S10 by using the camera calibration information 15 (internal calibration data) (Step S11).

The illumination information processing unit 42 acquires the illumination control information 17 from the illumination control information output unit 32. Furthermore, the illumination information processing unit 42 acquires the illumination device setting information 13 (Step S12).

The Illumination information processing unit 42 generates the illuminated background image Ia (Step S13).

The illumination information processing unit 42 performs distortion correction on the illuminated background image Ia generated in Step S13 by using the camera calibration information 15 (external calibration data) (Step S14).

The illumination information processing unit 42 outputs the illuminated background image Ia to the foreground clipping processing unit 44a (Step S15).

The illumination information processing unit 42 outputs the illuminated background image Ia to the texture correction processing unit 45a (Step S16).

The Illumination information processing unit 42 determines whether it is the last frame (Step S17). When it is determined that it is the last frame (Step S17: Yes), the video generation/display device 10a ends the processing in FIG. 11. In contrast, when it is not determined that it is the last frame (Step S17: No), the processing returns to Step S10.

[1-11. Flow of Foreground Clipping Processing Performed by Video Generation/Display Device of First Embodiment]

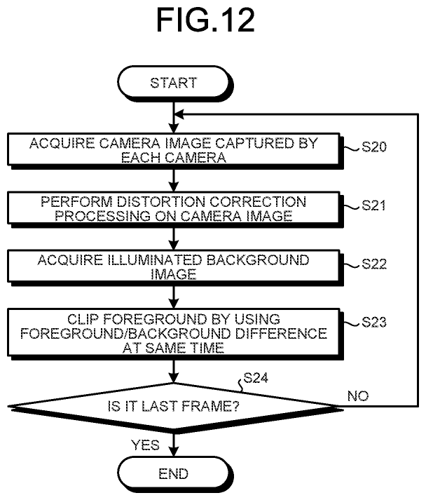

Next, the flow of the foreground clipping processing performed by the video generation/display device 10a will be described with reference to FIG. 12. FIG. 12 is a flowchart illustrating one example of the flow of the foreground clipping processing in the first embodiment.

The imaging unit 43 acquires the camera image Id captured by each camera 14 at each time (Step S20).

Furthermore, the imaging unit 43 performs distortion correction on the camera image Id acquired in Step S20 by using the camera calibration information 15 (internal calibration data) (Step S21).

The foreground clipping processing unit 44a acquires the illuminated background image Ia from the illumination information processing unit 42 (Step S22).

The foreground clipping processing unit 44a clips the foreground (subject 18) from the camera image Id by using a panorama/background difference at the same time (Step S23).

The foreground clipping processing unit 44a determines whether it is the last frame (Step S24). When it is determined that it is the last frame (Step S24: Yes), the video generation/display device 10a ends the processing in FIG. 12. In contrast, when it is not determined that it is the last frame (Step S24: No), the processing returns to Step S20.

[1-12. Flow of Texture Correction Processing Performed by Video Generation/Display Device of First Embodiment]

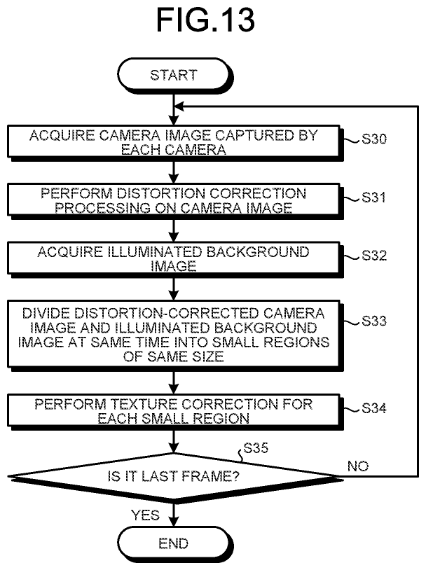

Next, the flow of the texture correction processing performed by the video generation/display device 10a will be described with reference to FIG. 13. FIG. 13 is a flowchart illustrating one example of the flow of the texture correction processing in the first embodiment.

The imaging unit 43 acquires the camera image Id captured by each camera 14 at each time (Step S30).

Furthermore, the imaging unit 43 performs distortion correction on the camera image Id acquired in Step S30 by using the camera calibration information 15 (internal calibration data) (Step S31).

The texture correction processing unit 45a acquires the illuminated background image Ia from the illumination information processing unit 42 (Step S32).

The texture correction processing unit 45a divides the distortion-corrected camera image Id and the illuminated background image Ia at the same time into small regions of the same size (Step S33).

The texture correction processing unit 45a performs texture correction for each small region divided in Step S33 (Step S34).

The texture correction processing unit 45a determines whether it is the last frame (Step S35). When it is determined that it is the last frame (Step S35: Yes), the video generation/display device 10a ends the processing in FIG. 13. In contrast, when it is not determined that it is the last frame (Step S35: No), the processing returns to Step S30.

[1-13. Effects of First Embodiment]

As described above, according to the video generation/display device 10a (image processing device) of the first embodiment, the imaging unit 43 (first acquisition unit) acquires an image obtained by imaging, at each time, the subject 18 (object) in a situation in which the state of the illumination device 11 changes at each time, and the illumination control information input unit 41 (second acquisition unit) acquires the state of the illumination device 11 at each time when the imaging unit 43 captures an image. Then, the foreground clipping processing unit 44a (clipping unit) clips the subject 18 from the image captured by the imaging unit 43 based on the state of the illumination device 11 at each time acquired by the illumination control information input unit 41. The modeling processing unit 46 (model generation unit) generates the 3D model of the subject 18 clipped by the foreground clipping processing unit 44a.

This allows the region of the subject to be clipped with high accuracy even when the state of illumination changes at each time as in a music live venue. Therefore, a high-quality 3D model and a volumetric video can be generated.

Furthermore, according to the video generation/display device 10a (image processing device) of the first embodiment, the texture correction processing unit 45a (correction unit) corrects the texture of an image captured by the imaging unit 43 in accordance with the state of the illumination device 11 at each time based on the state of the illumination device 11 at each time acquired by the illumination control information input unit 41.

This allows the texture of the subject 18 observed under usual illumination to be estimated from the texture of the subject 18 appearing in an image captured in a state in which the state of illumination changes at each time.

Furthermore, in the video generation/display device 10a (image processing device) of the first embodiment, the state of the illumination device 11 includes at least the position, direction, color, and luminance of the illumination device 11.

This allows the detailed state of the illumination device 11, which changes at each time, to be reliably acquired.

Furthermore, in the video generation/display device 10a (image processing device) of the first embodiment, an image captured by the camera 14 is obtained by imaging the direction of the subject 18 from the surroundings of the subject 18 (object).

This allows the 3D model 18M obtained by observing the subject 18 from various free viewpoints to be generated.

Furthermore, in the video generation/display device 10a (image processing device) of the first embodiment, the modeling processing unit 46 (model generation unit) generates the 3D model 18M of the subject 18 by clipping the region of the subject 18 from an image obtained by imaging, at each time, the subject 18 (object) in a situation in which the state of the illumination device 11 changes at each time based on the state of the illumination device 11, which changes at each time. Then, the rendering unit 91 (drawing unit) draws the 3D model 18M generated by the modeling processing unit 46.

This allows the region of the subject 18 to be clipped from an image captured in a situation in which the state of illumination changes to draw a video viewed from a free viewpoint.

Furthermore, in the video generation/display device 10a (image processing device) of the first embodiment, the texture correction processing unit 45a (correction unit) corrects the texture of the subject 18 in accordance with the state of the illumination device 11 at each time from an image obtained by imaging, at each time, the subject 18 (object) in a situation in which the state of the illumination device 11 changes at each time based on the state of the illumination device 11, which changes at each time. Then, the rendering unit 91 (drawing unit) draws the subject 18 by using the texture corrected by the texture correction processing unit 45a.

This allows the texture of the subject 18 appearing in an image captured in a situation in which the state of illumination changes to be corrected to draw a volumetric video viewed from a free viewpoint.

Furthermore, the video generation/display device 10a (image processing device) of the first embodiment acquires, at each time, an image obtained by imaging, at each time, the subject 18 (object) in a situation in which the state of illumination changes at each time and the state of the illumination device 11 at each time, and clips the region of the subject 18 from an image of the subject 18 and generates the model data 48 of the subject 18 based on the state of the illumination device 11 acquired at each time.

This allows the region of the subject to be clipped with high accuracy even when the state of illumination changes at each time, so that a high-quality 3D model can be generated.

### 2. Second Embodiment

[2-1. Functional Configuration of Video Generation/Display Device of Second Embodiment]

The video generation/display device 10a described in the first embodiment acquires an illumination state at each time based on the illumination control information 17, and performs foreground clipping and texture correction based on the acquired illumination state at each time. According to this method, object clipping and texture correction can be performed by simple calculation processing. Versatility is required to be improved in order to stably address a more complicated environment. A video generation/display device 10b of a second embodiment to be described below further enhances the versatility of foreground clipping and texture correction by using a learning model created by using deep learning.

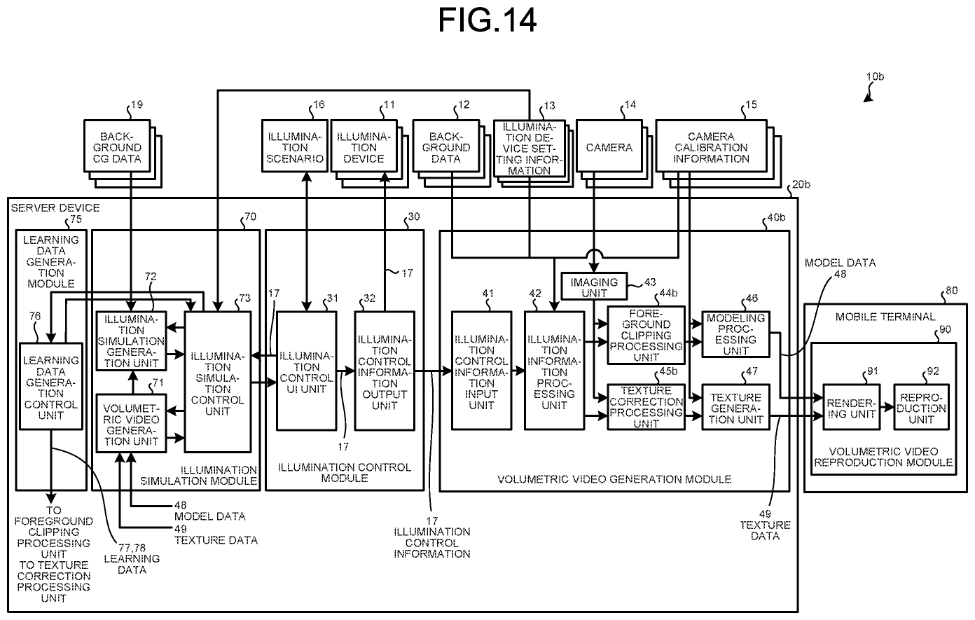

The functional configuration of the video generation/display device 10b of the second embodiment will be described with reference to FIG. 14. FIG. 14 is a functional block diagram illustrating one example of the functional configuration of the video generation/display device of the second embodiment. Note that the hardware configuration of the video generation/display device 10b is the same as the hardware configuration of the video generation/display device 10a (See FIGS. 4 and 5).

The video generation/display device 10b includes a server device 20b and the mobile terminal 80. The server device 20b includes the illumination control module 30, a volumetric video generation module 40b, an illumination simulation module 70, and a learning data generation module 75.

The illumination control module 30 is as described in the first embodiment (see FIG. 6).

The volumetric video generation module 40b includes a foreground clipping processing unit 44b instead of the foreground clipping processing unit 44a in contrast to the volumetric video generation module 40a described in the first embodiment. Furthermore, a texture correction processing unit 45b is provided instead of the texture correction processing unit 45a.

The foreground clipping processing unit 44b clips the region of the subject 18 (object) from the image captured by the camera 14 based on learning data obtained by learning the relation between the state of the illumination device 11 at each time acquired by the illumination control information input unit 41 and the region of the subject 18.

The texture correction processing unit 45b corrects the texture of the subject 18 appearing in the image captured by the camera 14 in accordance with the state of the illumination device 11 at each time based on learning data obtained by learning the relation between the state of the illumination device 11 at each time acquired by the illumination control information input unit 41 and the texture of the subject 18.

The illumination simulation module 70 generates an illumination simulation video obtained by simulating the state of illumination which changes at each time on background CG data 19 or a volumetric video based on the illumination control information 17. The illumination simulation module 70 includes a volumetric video generation unit 71, an illumination simulation generation unit 72, and the illumination simulation control unit 73.

The volumetric video generation unit 71 generates a volumetric video of the subject 18 based on the model data 48 and the texture data 49 of the subject 18 and a virtual viewpoint position.

The illumination simulation generation unit 72 generates a simulation video in which the subject 18 is observed in the state of being illuminated based on the given illumination control information 17, the volumetric video generated by the volumetric video generation unit 71, and the virtual viewpoint position.

The illumination simulation control unit 73 transmits the illumination control information 17 and the virtual viewpoint position to the illumination simulation generation unit 72.

The learning data generation module 75 generates a learning model for performing foreground clipping processing and a learning model for performing texture correction processing. The learning data generation module 75 includes a learning data generation control unit 76.

The learning data generation control unit 76 generates learning data 77 for foreground clipping and learning data 78 for texture correction based on the illumination simulation video generated by the illumination simulation module 70. Note that the learning data 77 is one example of first learning data in the present disclosure. Furthermore, the learning data 78 is one example of second learning data in the present disclosure. Note that a specific method of generating the learning data 77 and the learning data 78 will be described later.

[2-2. Foreground Clipping Processing]

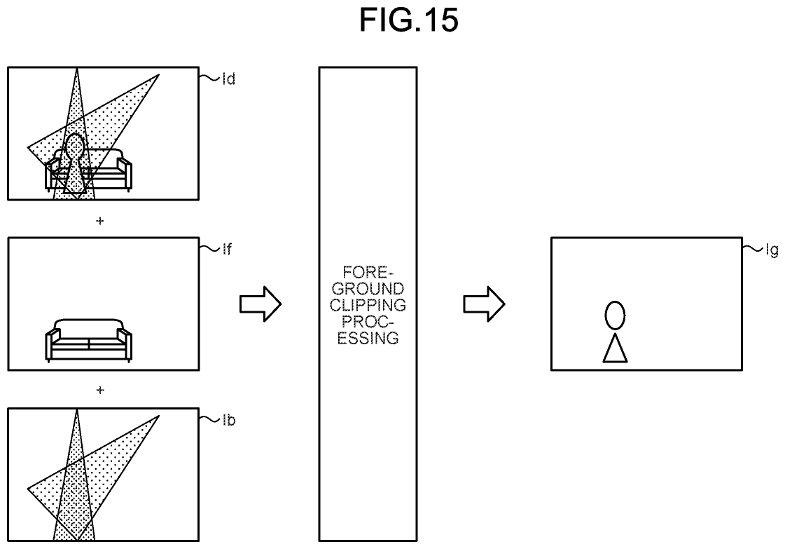

Next, foreground clipping processing performed by the video generation/display device 10b will be described with reference to FIG. 15. FIG. 15 outlines foreground clipping processing using deep learning.

The foreground clipping processing unit 44b clips the region of the subject 18 from the camera image Id captured by the camera 14 by using the learning data 77. The foreground clipping processing is performed at this time based on the learning data 77 (first learning data) generated by the learning data generation control unit 76.

The learning data 77 is a kind of discriminator generated by the learning data generation control unit 76 causing deep learning of the relation between the camera image Id, a background image If stored in the background data 12, the foreground clipped illumination image Ib, and the region of the subject 18 obtained therefrom to be performed. Then, the learning data 77 outputs a subject image Ig obtained by clipping the region of the subject 18 in response to the input of any camera image Id, background image If, and foreground clipped illumination image Ib at the same time.

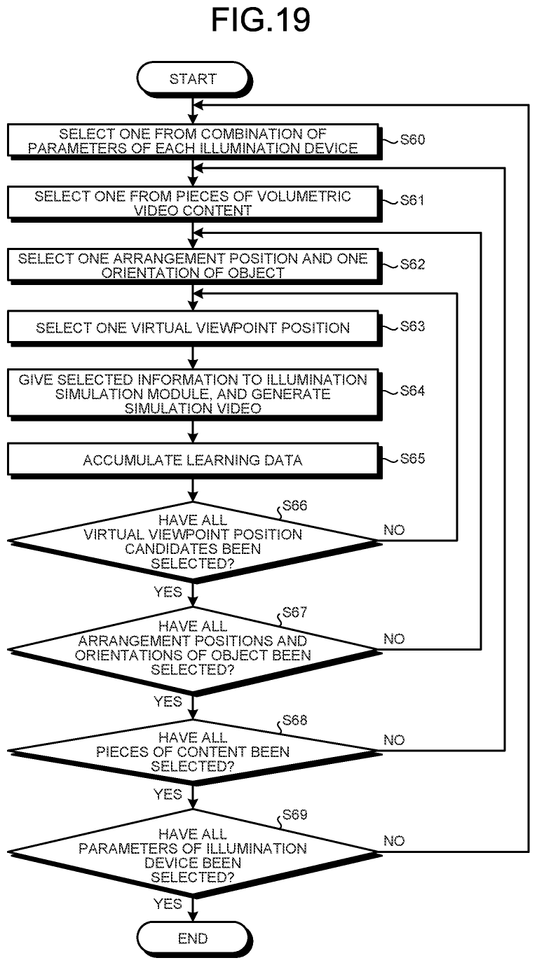

In order to generate highly reliable learning data 77, learning with as much data as possible is needed. Therefore, the video generation/display device 10b generates the learning data 77 as exhaustively as possible by the illumination simulation module 70 simulating a volumetric video in which a 3D model based on the model data 48 is arranged in an illumination environment caused by the illumination device 11 to the background CG data 19. A detailed processing flow will be described later (see FIG. 19).

[2-3. Texture Correction Processing]

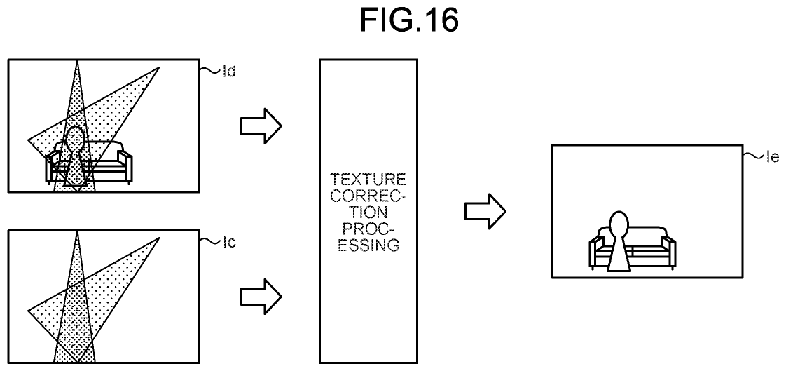

Next, texture correction processing performed by the video generation/display device 10b will be described with reference to FIG. 16. FIG. 16 outlines texture correction processing using deep learning.

The texture correction processing unit 45b corrects the texture of the subject 18 in a camera image captured by the camera 14 to a texture in, for example, a standard illumination state by using the learning data 78. The texture processing is performed at this time based on the learning data 78 (second learning data) generated by the learning data generation control unit 76.

The learning data 78 is a kind of discriminator generated by the learning data generation control unit 76 causing deep learning of the relation between the camera image Id, the texture corrected illumination image Ic, and the texture of the subject 18 obtained therefrom to be performed. Then, the learning data 78 outputs the texture corrected image Ie in which texture correction is performed on the region of the subject 18 in response to the input of any camera image Id and texture corrected illumination image Ic at the same time.

In order to generate highly reliable learning data 78, learning with as much data as possible is needed. Therefore, the video generation/display device 10b generates the learning data 78 as exhaustively as possible by the illumination simulation module 70 simulating a volumetric video in which a 3D model based on the model data 48 is arranged in an illumination environment caused by the illumination device 11. A detailed processing flow will be described later (see FIG. 19).

[2-4. Flow of Processing Performed by Video Generation/Display Device of Second Embodiment]

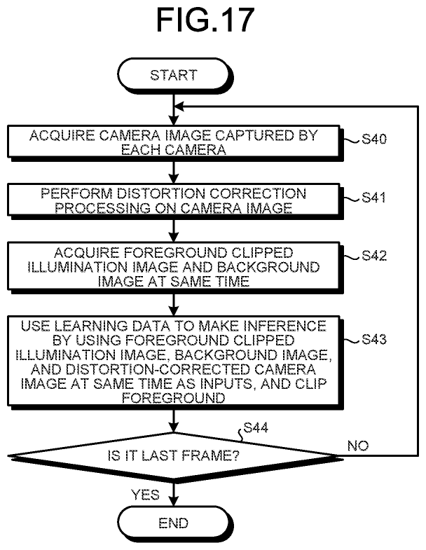

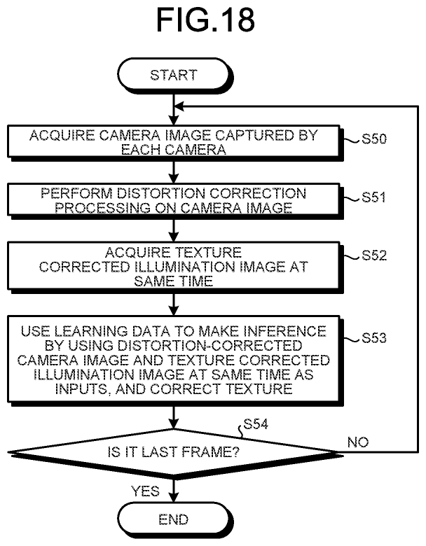

Next, the flow of processing performed by a video generation/display device 1b will be described with reference to FIGS. 17, 18, and 19. FIG. 17 is a flowchart illustrating one example of the flow of the foreground clipping processing in the second embodiment. FIG. 18 is a flowchart illustrating one example of the flow of the texture correction processing in the second embodiment. Then, FIG. 19 is a flowchart illustrating one example of a specific procedure of generating learning data.

First, the flow of foreground clipping processing in the second embodiment will be described with reference to FIG. 17. The imaging unit 43 acquires the camera image Id captured by each camera 14 at each time (Step S40).

Furthermore, the imaging unit 43 performs distortion correction on the camera image Id acquired in Step S40 by using the camera calibration information 15 (internal calibration data) (Step S41).

The foreground clipping processing unit 44b acquires the foreground clipped illumination image Ib from the illumination information processing unit 42. Furthermore, the foreground clipping processing unit 44b acquires the background image If (Step S42).

The foreground clipping processing unit 44b uses the learning data 77 to make inference by using the foreground clipped illumination image Ib, the background image If, and the distortion-corrected camera image Id at the same time as inputs, and clips a foreground from the camera image Id (Step S43).

The foreground clipping processing unit 44b determines whether it is the last frame (Step S44). When it is determined that it is the last frame (Step S44: Yes), the video generation/display device 10b ends the processing in FIG. 17. In contrast, when it is not determined that it is the last frame (Step S44: No), the processing returns to Step S40.

Next, the flow of texture correction processing in the second embodiment will be described with reference to FIG. 18. The imaging unit 43 acquires the camera image Id captured by each camera 14 at each time (Step S50).

Furthermore, the imaging unit 43 performs distortion correction on the camera image Id acquired in Step S50 by using the camera calibration information 15 (internal calibration data) (Step S51).

The texture correction processing unit 45b acquires the texture corrected illumination image Ic at the same time as the camera image Id from the illumination information processing unit 42. Furthermore, the foreground clipping processing unit 44b acquires the background image If (Step S52).

The texture correction processing unit 45b uses the learning data 78 to make inference by using the distortion-corrected camera image Id and the texture corrected illumination image Ic at the same time as inputs, and corrects the texture of the subject 18 appearing in the camera image Id (Step S53).

The texture correction processing unit 45b determines whether it is the last frame (Step S54). When it is determined that it is the last frame (Step S54: Yes), the video generation/display device 10b ends the processing in FIG. 18. In contrast, when it is not determined that it is the last frame (Step S54: No), the processing returns to Step S50.

Next, a procedure of generating the learning data 77 and 78 will be described with reference to FIG. 19. FIG. 19 is a flowchart illustrating one example of a procedure of generating learning data.

The learning data generation control unit 76 selects one from a combination of parameters of each illumination device 11 (Step S60).

The learning data generation control unit 76 selects one from pieces of volumetric video content (Step S61).

The learning data generation control unit 76 selects one arrangement position and one orientation of an object (Step S62).

The learning data generation control unit 76 selects one virtual viewpoint position (Step S63).

The learning data generation control unit 76 gives the selected information to the illumination simulation module 70, and generates a simulation video (volumetric video and illuminated background image Ia (foreground clipped illumination image Ib and texture corrected illumination image Ic)) (Step S64).

The learning data generation control unit 76 performs clipping processing and texture correction processing of an object on the simulation video generated in Step S64, and accumulates the learning data 77 and the learning data 78 obtained as a result (Step S65).

The learning data generation control unit 76 determines whether all virtual viewpoint position candidates have been selected (Step S66). When it is determined that all the virtual viewpoint position candidates have been selected (Step S66: Yes), the processing proceeds to Step S67. In contrast, when it is not determined that all the virtual viewpoint position candidates have been selected (Step S66: No), the processing returns to Step S63.

The learning data generation control unit 76 determines whether all the arrangement positions and orientations of an object have been selected (Step S67). When it is determined that all the arrangement positions and orientations of the object have been selected (Step S67: Yes), the processing proceeds to Step S68. In contrast, when it is not determined that all the arrangement positions and orientations of the object have been selected (Step S67: No), the processing returns to Step S62.

The learning data generation control unit 76 determines whether all pieces of the volumetric video content have been selected (Step S68). When it is determined that all the pieces of the volumetric video content have been selected (Step S68: Yes), the processing proceeds to Step S69. In contrast, when it is not determined that all the pieces of volumetric video content have been selected (Step S68: No), the processing returns to Step S61.

The learning data generation control unit 76 determines whether all parameters of the illumination device 11 have been selected (Step S69). When it is determined that all the parameters of the illumination device 11 have been selected (Step S69: Yes), the video generation/display device 10b ends the processing in FIG. 19. In contrast, when it is not determined that all the parameters of the illumination device 11 have been selected (Step S369: No), the processing returns to Step S60.

[2-5. Variation of Second Embodiment]

Although the second embodiment has been described above, a method of implementing the described function can have various variations.

For example, when the foreground clipping processing is performed, inference may be made by directly inputting the illumination control information 17, which is numerical information, to the learning data generation control unit 76 instead of using the foreground clipped illumination image Ib. Furthermore, inference may be made by directly inputting external calibration data (data that specifies position and orientation of camera 14) of the camera 14 to the learning data generation control unit 76 instead of inputting a virtual viewpoint position. Moreover, inference may be made without inputting the background image If under standard illumination.

Furthermore, when the texture correction processing is performed, inference may be made by directly inputting the illumination control information 17, which is numerical information, to the learning data generation control unit 76 instead of using the texture corrected illumination image Ic. Furthermore, inference may be made by directly inputting external calibration data (data that specifies position and orientation of camera 14) of the camera 14 to the learning data generation control unit 76 instead of inputting a virtual viewpoint position.

Furthermore, the foreground clipping processing may be performed by a conventional method by using a result of the texture correction processing. In this case, only the learning data 78 is needed, and generating the learning data 77 is not needed.

Note that any format of model may be used as an input/output model used when the learning data generation control unit 76 performs deep learning. Furthermore, an inference result of the previous frame may be fed back when inferring a new frame.

[2-6. Effects of Second Embodiment]

As described above, according to the video generation/display device 10b (image processing device) of the second embodiment, the foreground clipping processing unit 44b (clipping unit) clips the region of the subject 18 from the image acquired by the imaging unit 43 (first acquisition unit) based on the learning data 77 (first learning data) obtained by learning the relation between the state of the illumination device 11 at each time acquired by the illumination control information input unit 41 (second acquisition unit) and the region of the subject 18 (object).

This allows the subject 18 (foreground) to be clipped with high accuracy regardless of a use environment.

Furthermore, according to the video generation/display device 10b (image processing device) of the second embodiment, the texture correction processing unit 45b (correction unit) corrects the texture of the subject 18 acquired by the imaging unit 43 (first acquisition unit) in accordance with the state of the illumination device 11 at each time based on the learning data 78 (second learning data) obtained by learning the relation between the state of the illumination device 11 at each time acquired by the illumination control information input unit 41 (second acquisition unit) and the texture of the subject 18 (object).

This allows the texture of the subject 18 to be stably corrected regardless of a use environment.

Furthermore, according to the video generation/display device 10b (image processing device) of the second embodiment, the modeling processing unit 46 (model generation unit) generates the 3D model 18M of the subject 18 by clipping the region of the subject 18 from an image having the subject 18 based on the learning data 77 (first learning data) obtained by learning the relation between the state of the illumination device 11 at each time and the region of the subject 18 (object) in the image obtained at each time.

This allows the 3D model 18M of the subject 18 to be generated with high accuracy regardless of a use environment. In particular, images obtained by capturing the subject 18 from the surroundings at the same time can be simultaneously inferred, which can give consistency to a result of clipping a region from each image.

Furthermore, according to the video generation/display device 10b (image processing device) of the second embodiment, the texture correction processing unit 45b (correction unit) corrects the texture of the subject 18 imaged at each time in accordance with the state of the illumination device 11 at each time based on the learning data 78 (second learning data) obtained by learning the relation between the state of the illumination device 11 at each time and the texture of the subject 18 (object).

This allows the texture of the subject 18 to be stably corrected regardless of a use environment. In particular, images obtained by capturing the subject 18 from the surroundings at the same time can be simultaneously inferred, which can give consistency to a result of texture correction on each image.

Furthermore, in the video generation/display device 10b (image processing device) of the second embodiment, the learning data generation control unit 76 generates the learning data 77 by acquiring, at each time, an image obtained by imaging, at each time, the subject 18 (object) in a situation in which the state of the illumination device 11 changes at each time and the state of the illumination device 11, clipping the subject 18 from an image including the subject 18 based on the acquired state of the illumination device 11 at each time, and learning the relation between the state of the illumination device 11 at each time and the region of the clipped subject 18.

This allows the learning data 77 for clipping the subject 18 to be easily generated. In particular, the video generation/display device 10b that generates a volumetric video can easily and exhaustively generate a large amount of learning data 77 in which various virtual viewpoints, various illumination conditions, and various subjects are freely combined.

Furthermore, in the video generation/display device 10b (image processing device) of the second embodiment, the learning data generation control unit 76 generates the learning data 78 by acquiring, at each time, an image obtained by imaging, at each time, the subject 18 (object) in a situation in which the state of the illumination device 11 changes at each time and the state of the illumination device 11 and learning the relation between the state of the illumination device 11 at each time and the texture of the clipped subject 18 based on the acquired state of the illumination device 11 at each time.

This allows the learning data 78 for correcting the texture of the subject 18 to be easily generated. In particular, the video generation/display device 10b that generates a volumetric video can easily and exhaustively generate a large amount of learning data 78 in which various virtual viewpoints, various illumination conditions, and various subjects are freely combined.

Note that the effects set forth in the present specification are merely examples and not limitations. Other effects may be obtained. Furthermore, the embodiments of the present disclosure are not limited to the above-described embodiments, and various modifications can be made without departing from the gist of the present disclosure.

For example, the present disclosure may also have the configurations as follows.

(1)

An image processing device including:

a first acquisition unit that acquires an image obtained by imaging, at each time, an object in a situation in which a state of illumination changes at each time;

a second acquisition unit that acquires the state of illumination at each time;

a clipping unit that clips a region of the object from the image based on the state of illumination at each time acquired by the second acquisition unit; and

a model generation unit that generates a 3D model of the object clipped by the clipping unit.

(2)

The image processing device according to (1), further including

a correction unit that corrects a texture of the image in accordance with the state of illumination at each time based on the state of illumination at each time acquired by the second acquisition unit.

(3)

The image processing device according to (1) or (2),

wherein the clipping unit

clips the region of the object from the image acquired by the first acquisition unit based on first learning data obtained by learning relation between the state of illumination at each time acquired by the second acquisition unit and the region of the object.

(4)

The image processing device according to any one of (1) to (3),

wherein the correction unit

corrects a texture of the object acquired by the first acquisition unit in accordance with the state of illumination at each time based on second learning data obtained by learning relation between the state of illumination at each time acquired by the second acquisition unit and the texture of the object.

(5)

The image processing device according to any one of (1) to (4),

wherein the state of illumination includes

at least a position of illumination, a direction of the illumination, color of the illumination, and luminance of the illumination.

(6)

The image processing device according to any one of (1) to (5),

wherein the image is

obtained by imaging a direction of the object from surroundings of the object.

(7)

An image processing device including:

a model generation unit that generates a 3D model of an object by clipping a region of the object from an image obtained by imaging, at each time, the object in a situation in which a state of illumination changes at each time based on the state of illumination which changes at each time; and

a drawing unit that draws the 3D model generated by the model generation unit.

(8)

The image processing device according to (7), further including

a correction unit that corrects a texture of an object in accordance with a state of illumination at each time from an image obtained by imaging, at each time, the object in a situation in which the state of illumination changes at each time based on the state of illumination which changes at each time,

wherein the drawing unit draws the object by using the texture corrected by the correction unit.

(9)

The image processing device according to (7) or (8),

wherein the model generation unit

generates a 3D model of the object by clipping the region of the object from the image based on first learning data obtained by learning relation between the state of illumination at each time and the region of the object from an image captured at each time.

(10)

The image processing device according to any one of (7) to (9),

wherein the correction unit

corrects a texture of the object imaged at each time in accordance with the state of illumination at each time based on second learning data obtained by learning relation between the state of illumination at each time and the texture of the object.

(11)

A method of generating a 3D model, including:

acquiring an image obtained by imaging, at each time, an object in a situation in which a state of illumination changes at each time;

acquiring the state of illumination at each time;

clipping the object from the image based on the state of illumination acquired at each time; and

generating the 3D model of the object that has been clipped.

(12)

A learning method including:

acquiring an image obtained by imaging, at each time, an object in a situation in which a state of illumination changes at each time;

acquiring the state of illumination at each time;

clipping the object from the image based on the state of illumination at each time, which has been acquired; and

leaning relation between the state of illumination at each time and a region of the object that has been clipped.

(13)

The learning method according to (12), including

acquiring an image obtained by imaging, at each time, an object in a situation in which a state of illumination changes at each time;

acquiring the state of illumination at each time; and

learning relation between the state of illumination at each time and a texture of the object based on the state of illumination at each time, which has been acquired.

(14)

A program causing a computer to function as:

a first acquisition unit that acquires an image obtained by imaging, at each time, an object in a situation in which a state of illumination changes at each time;

a second acquisition unit that acquires the state of illumination at each time;

a clipping unit that clips a region of the object from the image based on the state of illumination at each time acquired by the second acquisition unit; and

a model generation unit that generates a 3D model of the object clipped by the clipping unit.

(15)

A program causing a computer to function as:

a model generation unit that generates a 3D model of an object by clipping a region of the object from an image obtained by imaging, at each time, the object in a situation in which a state of illumination changes at each time based on the state of illumination which changes at each time; and

a drawing unit that draws the 3D model generated by the model generation unit.

### REFERENCE SIGNS LIST

10a, 10b VIDEO GENERATION/DISPLAY DEVICE (IMAGE PROCESSING DEVICE)
11 ILLUMINATION DEVICE
12 BACKGROUND DATA
13 ILLUMINATION DEVICE SETTING INFORMATION
14 CAMERA
15 CAMERA CALIBRATION INFORMATION
16 ILLUMINATION SCENARIO
17 ILLUMINATION CONTROL INFORMATION
18 SUBJECT (OBJECT)
18M 3D MODEL
20a, 20b SERVER DEVICE
30 ILLUMINATION CONTROL MODULE
31 ILLUMINATION CONTROL UI UNIT
32 ILLUMINATION CONTROL INFORMATION OUTPUT UNIT
40a, 40b VOLUMETRIC VIDEO GENERATION MODULE
41 ILLUMINATION CONTROL INFORMATION INPUT UNIT (SECOND ACQUISITION UNIT)
42 ILLUMINATION INFORMATION PROCESSING UNIT
43 IMAGING UNIT (FIRST ACQUISITION UNIT)
44a, 44b FOREGROUND CLIPPING PROCESSING UNIT (CLIPPING UNIT)
45a, 45b TEXTURE CORRECTION PROCESSING UNIT (CORRECTION UNIT)
46 MODELING PROCESSING UNIT (MODEL GENERATION UNIT)
47 TEXTURE GENERATION UNIT
48 MODEL DATA
49 TEXTURE DATA
70 ILLUMINATION SIMULATION MODULE
75 LEARNING DATA GENERATION MODULE
77 LEARNING DATA (FIRST LEARNING DATA)
78 LEARNING DATA (SECOND LEARNING DATA)
80 MOBILE TERMINAL
90 VOLUMETRIC VIDEO REPRODUCTION MODULE
91 RENDERING UNIT (DRAWING UNIT)
92 REPRODUCTION UNIT
Ia ILLUMINATED BACKGROUND IMAGE
Ib FOREGROUND CLIPPED ILLUMINATION IMAGE
Ic TEXTURE CORRECTED ILLUMINATION IMAGE
Id CAMERA IMAGE
Ie TEXTURE CORRECTED IMAGE
If BACKGROUND IMAGE
Ig SUBJECT IMAGE

1. An image processing device including:
a first acquisition unit that acquires an image obtained by imaging, at each time, an object in a situation in which a state of illumination changes at each time;
a second acquisition unit that acquires the state of illumination at each time;
a clipping unit that clips a region of the object from the image based on the state of illumination at each time acquired by the second acquisition unit; and
a model generation unit that generates a 3D model of the object clipped by the clipping unit.

2. The image processing device according to claim 1, further including
a correction unit that corrects a texture of the image in accordance with the state of illumination at each time based on the state of illumination at each time acquired by the second acquisition unit.

3. The image processing device according to claim 1,
wherein the clipping unit
clips the region of the object from the image acquired by the first acquisition unit based on first learning data obtained by learning relation between the state of illumination at each time acquired by the second acquisition unit and the region of the object.

4. The image processing device according to claim 2,
wherein the correction unit
corrects a texture of the object acquired by the first acquisition unit in accordance with the state of illumination at each time based on second learning data obtained by learning relation between the state of illumination at each time acquired by the second acquisition unit and the texture of the object.

5. The image processing device according to claim 1,
wherein the state of illumination includes
at least a position of illumination, a direction of the illumination, color of the illumination, and luminance of the illumination.

6. The image processing device according to claim 1,
wherein the image is
obtained by imaging a direction of the object from surroundings of the object.

7. An image processing device including:
a model generation unit that generates a 3D model of an object by clipping a region of the object from an image obtained by imaging, at each time, the object in a situation in which a state of illumination changes at each time based on the state of illumination which changes at each time; and
a drawing unit that draws the 3D model generated by the model generation unit.

8. The image processing device according to claim 7, further including
a correction unit that corrects a texture of an object in accordance with a state of illumination at each time from an image obtained by imaging, at each time, the object in a situation in which the state of illumination changes at each time based on the state of illumination which changes at each time,
wherein the drawing unit draws the object by using the texture corrected by the correction unit.

9. The image processing device according to claim 7,
wherein the model generation unit
generates a 3D model of the object by clipping the region of the object from the image based on first learning data obtained by learning relation between the state of illumination at each time and the region of the object from an image captured at each time.

10. The image processing device according to claim 8,
wherein the correction unit
corrects a texture of the object imaged at each time in accordance with the state of illumination at each time based on second learning data obtained by learning relation between the state of illumination at each time and the texture of the object.

11. A method of generating a 3D model, including:
acquiring an image obtained by imaging, at each time, an object in a situation in which a state of illumination changes at each time;
acquiring the state of illumination at each time;
clipping the object from the image based on the state of illumination acquired at each time; and
generating the 3D model of the object that has been clipped.

12. A learning method including:
acquiring an image obtained by imaging, at each time, an object in a situation in which a state of illumination changes at each time;
acquiring the state of illumination at each time;
clipping the object from the image based on the state of illumination at each time, which has been acquired; and
leaning relation between the state of illumination at each time and a region of the object that has been clipped.

13. The learning method according to claim 12, including
acquiring an image obtained by imaging, at each time, an object in a situation in which a state of illumination changes at each time;
acquiring the state of illumination at each time; and
learning relation between the state of illumination at each time and a texture of the object based on the state of illumination at each time, which has been acquired.

14. A program causing a computer to function as:
a first acquisition unit that acquires an image obtained by imaging, at each time, an object in a situation in which a state of illumination changes at each time;
a second acquisition unit that acquires the state of illumination at each time;
a clipping unit that clips a region of the object from the image based on the state of illumination at each time acquired by the second acquisition unit; and
a model generation unit that generates a 3D model of the object clipped by the clipping unit.

15. A program causing a computer to function as:
a model generation unit that generates a 3D model of an object by clipping a region of the object from an image obtained by imaging, at each time, the object in a situation in which a state of illumination changes at each time based on the state of illumination which changes at each time; and
a drawing unit that draws the 3D model generated by the model generation unit.
